(19) United States
(12) Patent Application Publication
(10) Pub. No.: US 2023/0120633 A1
(43) Pub. Date: Apr. 20, 2023

(54) Composition Generation and Presentation System

(71) Applicant: StageConnect Inc., Nashua, NH (US)

(72) Inventors: Cole Morgan, Nashua, NH (US); Matthew Michael Murphy, Jupiter, FL (US); Christopher T. Hogan, Evergreen, CO (US)

(21) Appl. No.: 17/968,470

(22) Filed: Oct. 18, 2022

Related U.S. Application Data
(60) Provisional application No. 63/257,095, filed on Oct. 18, 2021.

(51) Int. Cl. H04L 12/18; G06F 16/908

(52) U.S. Cl. CPC H04L 12/1822; G06F 16/908; H04L 12/1831

(57) ABSTRACT

Embodiments of the composition generation and presentation system disclosed herein connect a remote audience to a presenter on a stage (or other location) in real time. The remote audience members, called participants, connect via consumer hardware such as a laptop, desktop, tablet, or mobile device, equipped with a microphone and a web camera. The composition generation and presentation system is configured by an administrator controlled by a producer, both via corresponding user interfaces. The system takes actions based on the content of metadata (e.g., tags) associated with users. The presenter views the remote audience through the display of one or more compositions on a digital surface, such as TV, projector, or LED wall. Compositions are made up of participant streams organized into groups, patterns, or layouts, such as a grid.

### BACKGROUND

Live events have traditionally been in-person gatherings of people; often speakers, presenters or performers and an audience. Important elements of events have included the audience consuming the presenter's message or performance, the presenter interacting with the audience, and the audience interacting and sharing the experience with each other.

The interaction between presenter and audience in such traditional live events includes both 1) audience feedback in the form of clapping, cheering, call outs, and so on as well as 2) direct interaction between the presenter and one or more audience members in the form of questions, comments, participation in demonstrations, and so on.

The drawback of live events with in-person audiences is that as audience sizes increase, the quality of direct interaction drops. When picturing an in-person audience of thousands of people from the vantage point of a presenter on stage, it is easy to understand how little those individuals can be seen. Nor can they be accessed quickly (and clearly) for interactions like questions, comments, or participation.

With the advent of the digital age, it has become less critical that audience members be in-person at the same physical location (venue) as the presenters. One-to-many video streams allow remote audience members to view an event and consume the message or performance. One drawback of one-to-many video streams is that they do not allow the presenter to see or hear the audience, receive feedback, or interact. Nor do they allow remote audience members to see, hear, or interact with each other.

Video conferences allow smaller groups to interact. However, there are several drawbacks to video conferences, including that the total number of remote participants per “room” (server) can be capped and thus larger numbers of remote participants are not all accessible for display. Also, the quality of the interaction drops as the audience size increases. It becomes more difficult, and at times impossible, for the presenters to see and hear the entire audience or the desired sub-section thereof. Collective audience feedback becomes distracting or ceases to exist as participants mute themselves. Managing which remote audience members are visible to presenters or available for interaction becomes more difficult, time consuming, and expensive as audience size increases. This is because more computer and networking hardware and technicians are needed as audience size increases.

Software applications facilitate some forms of interaction, such as digital feedback (i.e. floating heart icons), text chat, and so on. Drawbacks of such software applications include that they alone do not fully emulate a live interaction between a presenter and one or multiple audience members. Nor do they emulate a live in-person shared experience between audience members.

### SUMMARY

Embodiments of the composition generation and presentation system disclosed herein connect a remote audience to a presenter on a stage (or other location) in real time. The remote audience members, called participants, connect via consumer hardware such as a laptop, desktop, tablet, or mobile device, equipped with a microphone and a web camera. The composition generation and presentation system is configured by an administrator controlled by a producer, both via corresponding user interfaces. The system takes actions based on the content of metadata (e.g., tags) associated with users. The presenter views the remote audience through the display of one or more compositions on a digital surface, such as TV, projector, or LED wall. Compositions are made up of participant streams organized into groups, patterns, or layouts, such as a grid.

### BRIEF DESCRIPTION OF THE DRAWINGS

FIG. 1 is a dataflow diagram of a system for generating a composition of data (e.g., audiovisual streams) from a plurality of users whose metadata satisfies one or more criteria according to one embodiment of the present invention.

FIG. 2 is a flowchart of a method performed by the system of FIG. 1 according to one embodiment of the present invention.

FIG. 3 is a dataflow diagram of an architecture of a composition generation system according to one embodiment of the present invention.

FIG. 4 is a dataflow diagram of components of the system of FIG. 3 according to one embodiment of the present invention.

FIG. 5 is a dataflow diagram of a system for generating composition status output according to one embodiment of the present invention.

FIG. 6 is a dataflow diagram of a system for allowing a plurality of participants attending a particular event to watch a main program stream while concurrently communicating with other participants attending that particular event via video and/or audio.

### DETAILED DESCRIPTION

Human beings have long held an instinct to gather, interact with persons of interest or attend events, and share that experience with others. The event types are as broad as people's interests and include concerts, performances, presentations, conferences, trainings, meetings, sporting, worship, and more. The unique dynamic of being present, being seen and heard, interacting and sharing the experience is as important for the presenters and performers (“stage high”) as it is for the audience members.

With advancements in networking and technology, presenters and event-goers now seek the same dynamic for all of these same types of live events in an online context where certain audience members or presenters are located remotely.

To fully replicate the in-person live event experience with remote participants, it should be the case that, by presenters or in-person participants, the remote participants can see and be seen, hear and be heard, provide feedback in various ways, and directly interact. It should be the case that one, a few, or many (thousands or more) remote participants can be displayed at a given time and include the ability to direct which remote participants are on display and/or interacting. Until now, this has not been possible in a single system.

Embodiments of the invention disclosed herein address these desired event-going outcomes, replicate an in-person audience experience for both presenters and remote participants, and extend the experience in ways not previously possible. It does this as described in detail below by, for example, aggregating the audio/video streams of remote participants so they can be managed and displayed on large screens on a stage or at a venue. The remote participants can be seen and heard as appropriate by the presenter and/or other event-goers, they can provide feedback, and they can interact directly. Remote participants can both experience the event as well as share the experience with other remote event-goers. The capabilities allow producers, technicians or presenters to manage aspects of which remote participants are “on screen” or are “interactive”. Embodiments of the present invention enable this to be done more cost-effectively, with far less hardware and far fewer technicians than previous technologies.

Embodiments of the present invention may, for example, include remote participants at in-person events by displaying them in a grid or other configuration on a display surface. Such a display of participants is also referred to herein as a “composition,” “participant wall,” or simply a “wall.” For example, the event may be a corporation's national sales award show. The show may have several thousand remote participants join and producers may call for displaying several hundred at a time on a curved LED wall behind the executives on a rotating basis. During the event, various sales teams may be displayed to be highlighted by or to interact with executives. During award presentations, the sub-group of award nominees could be displayed and then the award winner upon announcement for direct interaction.

Having described aspects of certain embodiments of the present invention at a high level of generality and solely for the sake of example, examples of particular embodiments of the present invention will now be described in more detail.

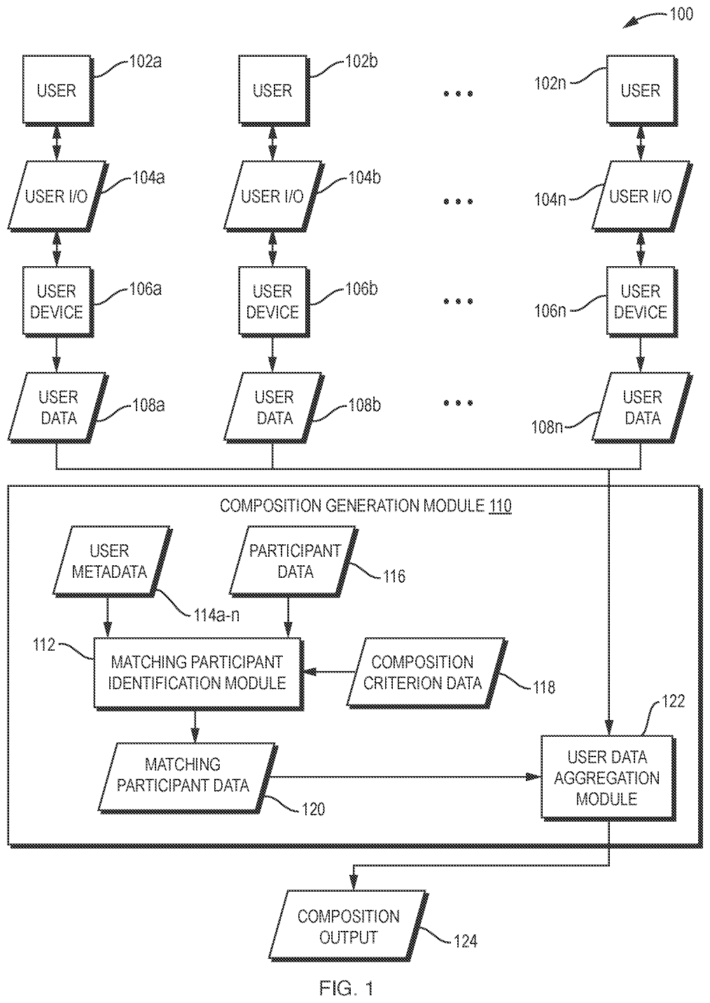

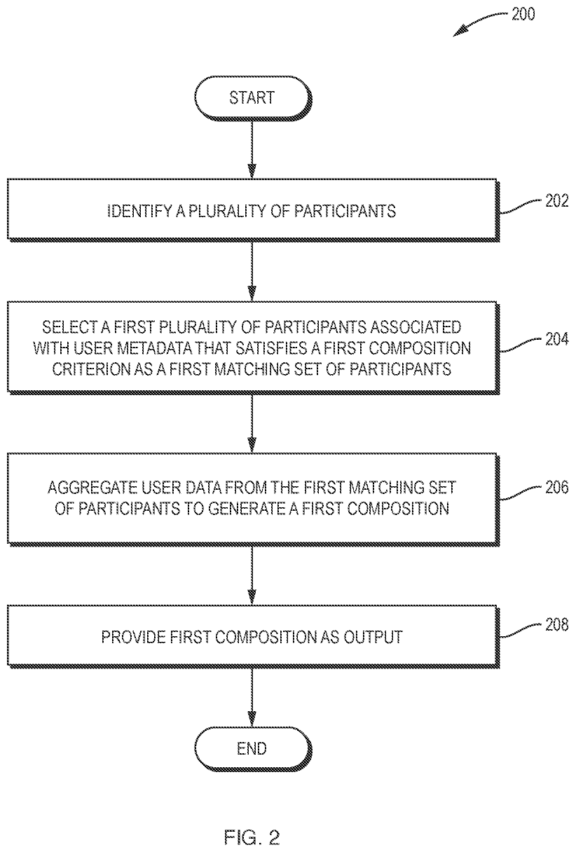

Referring to FIG. 1, a dataflow diagram is shown of a system 100 for generating a composition of data (e.g., audiovisual streams) from a plurality of users whose metadata satisfies one or more criteria according to one embodiment of the present invention. Referring to FIG. 2, a flowchart is shown of a method 200 performed by the system 100 of FIG. 1 according to one embodiment of the present invention.

The system 100 includes a plurality of users 102a-n, where n may be any number. The users 102a-n may, for example, be humans, hardware devices (e.g., computers), software applications, avatars (whether controlled manually or automatically), and images (e.g., logos), in any combination. The users 102a-n provide output and receive input from corresponding user devices 106a-n in the form of user I/O 104a-n. For example, user 102a provides/receives user I/O 104a to/from user device 106a; user 102b provides/receives user I/O 104b to/from user device 106b; and user 102n provides/receives user I/O 104n to/from user device 106n. Various examples of the user I/O 104a-n will be described below.

Each of the user devices 106a-n may, for example, include one or more computers, input devices, and/or output devices, in any combination, such as any of the kinds of computers, input devices, and output devices described below. As a particular example, any of the user devices 106a-n may include one or more digital surfaces, such as one or more TVs, projectors, and/or LED walls, in any combination, for generating audiovisual output of any of the kinds disclosed herein.

Each of the user devices 106a-n may, for example, be physically distinct from the other user devices 106a-n. As a particular example, each of the user devices 106a-n may be a physically distinct computer (having its own display device, either integrated within it or coupled to it). Alternatively, for example, two or more of the user devices 106a-n may be integrated with each other, e.g., into a single computer and/or display device, such that two or more of the users 102a-b may share a single physical user device to perform the functions disclosed herein.

The user devices 106a-n provide corresponding user data 108a-n as output and/or receive corresponding user data 108a-n as input. For example, user device 106a may provide user data 108a as output and/or receive user data 108a as input; user device 106b may provide user data 108b as output and/or receive user data 108b as input; and user device 106n may provide user data 108n as output and/or receive user data 108n as input. The user devices 106a-n may, for example, generate the corresponding user data 108a-n, in whole or in part, based on the input they receive from the corresponding users 102a-n in the corresponding user I/O 104a-n. As described in more detail herein, the composition generation module 110 and other components of embodiments of the present invention may receive the user data 108a-n as input.

The user data 108a-n may, for example, include any one or more of the following, in any combination:
one or more audio streams generated by some or all of the user devices 106a-n based on input received from some or all of the corresponding users 102a-n, such as one or more audio streams generated by the user devices 106a-n based on input received by microphones from some or all of the users 102a-n;
one or more video streams generated by some or all of the user devices 106a-n based on input received from some or all of the corresponding users 102a-n, such as one or more video streams generated by the user devices 106a-n based on input received by cameras from some or all of the users 102a-n;
metadata associated with the users 102a-n, such as any one or more of the following, in any combination: real name, username or other user ID, location, preferences, or any other metadata disclosed herein;
text and/or data (e.g., emojis) generated by some or all of the user devices 106a-n based on manual input received from some or all of the corresponding users 102a-n; and
text, images, audio, and/or video generated automatically by the system 100, such as data generated automatically based on user metadata 114a-n (described below), such as one or more names, usernames, and/or titles of the users 102a-n.

As the above implies, the user data 108a-n may include one or more audiovisual streams. Audio streams, video streams, and audiovisual streams are examples of live streaming data that may be output by the user devices 106a-n as the user data 108n, in whole or in part. As this implies, the user devices 106a-n may repeatedly (e.g., continuously) update such live streaming data within the user data 108a-n, such as in the case of audio and/or video streams generated by the user devices 106a-n based on live data generated by microphones and/or cameras receiving live audio and/or video input from the users 102a-n.

The user data 108a-n may, additionally or alternatively, include data which is static, at least for some period of time. For example, the user data corresponding to a particular user may include an identifier of that user (e.g., the user's real name, username, and/or email address), which is an example of static data that may persist within that user's user data for at least some period of time.

The system 100 may also include a composition generation module 110. In general, the composition generation module 110 may receive the user data 108a-n as input and, based on the user data 108a-n, generate composition output 124. Examples of ways in which the composition generation module 110 may generate the composition output 124 will now be described.

The composition generation module 110 may identify a plurality of participants, which may be represented by participant data 116 (FIG. 2, operation 202). The participant data 116 may include a plurality of records, each of which is referred to herein as a “participant record,” representing a corresponding participant. The participant data 116 may include any data which identifies some or all of the users 102a-n of the system 100. For example, each of the users 102a-n may be associated with a corresponding unique user identifier (ID), and the participant data 116 may identify each of the plurality of participants using that participant's unique user ID.

As will be described in more detail below, the system 100 may be used in connection with one or a plurality of events, which may occur in sequence and/or contemporaneously. The participant data 116 may, for example, represent a plurality of participants who are attending a particular event. For now, however, the description that immediately follows will refer to the participants data 116 without reference to events.

Each of the participants represented by the participant data 116 may be associated with corresponding metadata. For example, in FIG. 1, the composition generation module 110 is shown as containing user metadata records 114a-n (also referred to herein simply as “user metadata” or “metadata”), each of which corresponds to one of the users 102a-n. As this implies, the user metadata 114a-n may contain metadata associated with all of the participants represented by the participant data 116, as well as metadata associated with users who are not represented by the participant data 116 (because fewer than all of the users 102a-n are represented by the participant data 116).

The user metadata 114a-n may include, for example, for each of the users 102a-n, any one or more of the following, in any combination:
one or more tags, which may tag the form, for example, of one or more units of text and/or one or more tokens;
identifying information, such as one or more usernames, real names, passwords, addresses, and/or telephone numbers; and
a participant role (e.g., producer, presenter, attendee).

As described above, each of the participants represented by the participant data 116 may be associated with corresponding metadata. Each of the user metadata records 114a-n may be associated with a corresponding one of the participants represented by the participant data 116. Because “participants” are instances of the class of “users,” any reference herein to a “participant” also refers to a “user,” e.g., to a user who is represented by the participant data 116.

The composition generation module 110 also includes composition criterion data 118, which represents a criterion, and a matching participant identification module 112. As will be described in more detail below, the matching participant identification module 112 may identify a subset of the participant data 116 (representing a subset of the participants represented by the participant data 116) whose associated user metadata 114a-n satisfies the criterion represented by the composition criterion data 118. The matching participant identification module 112 outputs matching participant data 120 representing the set of participants (i.e., subset of the participants represented by the participant data 116) who associated user metadata 114a-n satisfies the composition criterion.

The composition criterion represented by the composition criterion data 118 may take any of a variety of forms. For example, the composition criterion may include any one or more of the following, in any combination:
a tag;
a participant role (e.g., participant, presenter, producer);
identifying user information, e.g., of any of the kinds described herein;
one or more user actions (e.g., raising a physical or virtual hand);
one or more user attributes, such as one or more attributes stored in the user data 108a-n and/or user metadata 114a-n.

The composition criterion may include a plurality of any of the above, such as a plurality of tags and/or a plurality of participant roles.

The composition criterion may include a plurality of any of the above, combined with any Boolean operators in any combination, e.g., (<Tag1> AND <Tag2>), or (<Tag1> OR<Tag2>). As this implies, a composition criterion may include a plurality of criteria in combination. More generally, the composition criterion may include one or more rules, the satisfaction of which may be treated by the matching participant identification module 112 as satisfying the composition criterion.

The matching participant identification module 112 may determine, for each of the plurality of participants represented by the participant data 116, whether that participant's associated metadata (within the user metadata 114a-n) satisfies the composition criterion represented by the composition criterion data 118. The matching participant identification module 112 may include, within the matching participant data 120, a record or other data representing each participant whose associated user metadata has been determined to satisfies the composition criterion represented by the composition criterion data 118.

As will be described in more detail below, the subset of participants that matches the composition criterion may change over time, such as in response to changes in any one or more of the following, in any combination:
the user metadata 114a-n;
the participant data 116 (e.g., in response to users being added to and/or removed from the participant data 116); and
the composition criterion data 118.

Therefore:
the user metadata 114a-n may represent first user metadata 114a-n, which may subsequently change;
the participant data 116 may represent first participant data, which may subsequently change; and
the composition criterion data may represent a first composition criterion, which may subsequently change.

The matching participant identification module 112 may select, as a first matching set of participants represented by the matching participant data 120, a first subset of the first plurality of participants (represented by the participant data 116), where each of the participants in the first subset of the first plurality of participants has associated user metadata which satisfies the first composition criterion (FIG. 2, operation 204). The matching participant data 120 may represent a plurality of participants, but fewer than all of the participants represented by the participant data 116.

The system 100 may use the matching participant data 120 to perform any of a variety of functions, such as aggregating user data from the first matching set of participants into a composition, marking one or more users in the first matching set of participants for future inclusion in a composition, selecting one or more users as “pinned” or “spotlighted” in a composition, providing different output to the first matching set of participants than is provided to a second matching set of participants, or creating an event having the first matching set of participants as participants. The following description will focus on aggregating user data into a composition.

The composition generation module 110 may include a user data aggregation module 122. In general, the user data aggregation module 122 may aggregate user data from the first matching set of participants to generate a first composition, represented in FIG. 1 by composition output 124 (FIG. 2, operation 206). In general, the user data aggregation module 122 may identify, for each of the participants represented by the matching participant data 120, corresponding user data within the user data 108a-n, and include the identified user data (and/or data derived therefrom) within the composition output 124. In this way, the composition generation module 110 may aggregate first user data from the first matching set of participants to generate a first composition (represented by the composition output 124) (FIG. 2, operation 208) and provide the first composition as output by outputting the composition output 24 (FIG. 2, operation 210).

For example, the composition output 124 may be or specify audio and/or video output (e.g., one or more audio streams, video streams, and/or audiovisual streams, in any combination) that includes and/or is derived from user data (within the user data 108a-n) corresponding to the users represented by the matching participant data 120. For example, if the user data 108a-n includes live audiovisual streams of the users 102a-n, the composition output 124 may include and/or specify live audiovisual streams of the user subset represented by the matching participant data 120. Such live audiovisual streams within the composition output 124 may, for example, be smaller (e.g., downsampled) versions of the live audiovisual streams in the user data 108a-n.

Although the description above refers to generating and outputting the single composition output 124, the system 100 may update the composition output 124, e.g., in response to updates in the user data 108a-n. The system 100 may or may not update the matching participant data 120 each time the system 100 updates the composition output 124. For example, the system 100 may generate the matching participant data 120 once and then generate the composition output 124, and then update the composition output 124 a plurality of times, based on updates to the user data 108a-n, without updating the matching participant data 120. This may occur if, for example, there are no updates to the user metadata 114a-n, the participant data 116, or the composition criterion data 118.

For example, if any of the user data 108a-n include streaming data (e.g., audio and/or video streaming data), then, once the composition generation module 110 has generated an initial instance of the composition output 124 based on the streaming data at a particular point in time, the composition generation module 110 may repeatedly (e.g., continuously, in real-time) update the composition output 124 to reflect updates in the streaming data within the user data 108a-n. In practice, this may take the form of a composition which outputs audiovisual streams of the subset of the users 102a-n who represented by the participant data 116.

The composition output 124 may arrange visual (e.g., image and/or video) output corresponding to the plurality of participants in any of a variety of layouts. For example, the composition output 124 may arrange such visual output in: a grid layout, arranged into any number of rows and columns, in any combination; a solo pin layout, in which only a single pinned user is included and displayed; a plurality of solo pins, in which a plurality of pinned users within the matching set of participants are included and displayed; a single row or column of users; and a collage, in which a plurality of users are displayed in different sizes and not in rows and columns. For example, if the participant data 116 represents 25 participants, the composition output 124 may include visual output from those 25 participants arranged in a 5×5 grid.

The composition output 124 may take the form of, or specify, two-dimensional output, such as the grid layout described above. As other examples, the composition output 124 may take the form of, include, or specify output that represents three-dimensional content, such as augmented reality (AR), virtual reality (VR), and/or mixed reality (MR) content. For example, the composition output 124 may include, for each of one or more of the users represented by the participant data 116, a corresponding avatar representing that user. As another example, the composition output 124 may include a rendering of a three-dimensional environment and include, within that environment, renderings of representations of some or all of the users represented by the participant data 116, such as live audio/video streams of such users and/or avatars of such users.

As these examples illustrate, the composition output 124 may include, for each of one or more of the users represented by the participant data 116, any one or more of the following, in any combination: (1) data derived from that user's user data (e.g., a live audio/video stream of that user); and (2) data that is not derived from that user's user data (e.g., a virtual background).

The composition generation module 110 may provide the composition output 124 to one or more devices. For example, the composition generation module 110 may provide a separate instance of the composition output 124 to each of the user devices 106a-n associated with users who are participants (as specified by the participant data 116). As this implies, the user I/O 104a-n may include instances of the composition output 124 (and/or output derived from the composition output 124). For example, if each of the users 102a-n uses a distinct corresponding one of the user devices 106a-n, then the composition generation module 110 may provide, to the user devices associated with the users represented by the participant data 116, an instance of the composition output 124. Those user devices may receive those instances of the composition output 124 and, in response, generate output based on the received instances of the composition output 124. As a particular example, those user devices may generate audio and/or video output representing the composition output 124, such as a grid displaying live audiovisual streams of the users represented by the participant data 116.

Any of a variety of data disclosed herein may be transmitted and received over one or more networks, such as the Internet. Such networks may include, for example, one or more local area networks (LANs) and/or one or more wide area networks (WANs), in any combination. For example, any one or more of the user devices 106a-n may transmit their user data 108a-n to the composition generation module 110 over one or more networks. As another example, the composition generation module 110 may transmit the composition output 124 to one or more of the user devices 106a-n over one or more networks.

The composition output 124 may or may not include output representing all of the participants whose user metadata matches the composition criterion. For example, the composition output 124 may include a subset (i.e., fewer than all) of the participants whose user metadata matches the composition criterion. This may be useful, for example, if the number of users whose user metadata matches the composition criterion is large, e.g., larger than a maximum number of users associated with the composition output, such as a maximum number of slots in a grid.

To implement such a limitation, the user data aggregation module 122 may select a first subset of the first matching set of participants as a first set of on-composition participants. The first subset of the first matching set of participants may include at least two of the first matching set of participants and fewer than all of the first matching set of participants. The user data aggregation module 122 may aggregate the first data from the first set of on-composition participants to generate the first composition represented by the composition output.

As the above implies, any particular participant may receive composition output that includes user data received from the participant. For example, if a particular participant's user metadata matches the composition criterion and the participant's user data fits within the layout of the composition, then the composition output 124 received by that participant's user device may include output (e.g., an audiovisual stream) derived from that participant's user data. Alternatively, for example, if a particular participant's user metadata does not match the composition criterion, or the particular participant's user metadata does match the composition criterion but the participant's user data does not fit within the layout of the composition, then the composition output 124 received by that participant's user device may not include output (e.g., an audiovisual stream) derived from that participant's user data.

The composition generation module 110 may update the matching participant data 120 and/or the composition output 124 in response to updates to any one or more of the following, in any combination:
the user data 108a-n;
the user metadata 114a-n;
the participant data 116; and
the composition criterion data 118.

Examples of updating the composition output 124 in response to updates in the user data 108a-n are described above in connection with the description of updating the composition output 124 to reflect updates to live audio/video streams received from the user devices 106a-n in the user data 108a-n.

The user metadata 114a-n may undergo an update in any of a variety of ways. For example, the metadata associated with any particular user may undergo a change in a datum (e.g., a change in a tag), addition of a datum (e.g., addition of a tag), or removal of a datum (e.g., removal of a tag), in any combination. The matching participant identification module 112 may, in response to and/or based on one or more such updates, repeat operation 204, described above, to select, as a second matching set of participants, a second subset of the participants represented by the participant data 116, where each of the participants in the second subset has associated user metadata which satisfies the composition criterion represented by the composition criterion data 118. The matching participant identification module 112 may output an updated version of the matching participant data 120, representing the second subset of the participants represented by the participant data 116. The matching participant data 120 may represent a plurality of participants, but fewer than all of the participants represented by the participant data 116.

In this way, the matching participant identification module 112 may update the set of participants represented by the matching participant data 120 to reflect those participants whose associated user metadata satisfies the composition criterion represented by the composition criterion data 118, in light of the update(s) to the user metadata 114a-n.

The participant data 116 may undergo an update in any of a variety of ways. For example, the participant data 116 may undergo a change which involves a user being added to the set of users specified by the participant data 116, and/or a user being removed from the set of users specified by the participant data 116. The matching participant identification module 112 may, in response to and/or based on one or more such updates, repeat operation 204, described above, to select, as a second matching set of participants, a second subset of the participants represented by the participant data 116, where each of the participants in the second subset has associated user metadata which satisfies the composition criterion represented by the composition criterion data 118. The matching participant identification module 112 may output an updated version of the matching participant data 120, representing the second subset of the participants represented by the participant data 116. The matching participant data 120 may represent a plurality of participants, but fewer than all of the participants represented by the participant data 116.

In this way, the matching participant identification module 112 may update the set of participants represented by the matching participant data 120 to reflect those participants whose associated user metadata satisfies the composition criterion represented by the composition criterion data 118, in light of the update(s) to the participant data 116.

The composition criterion data 118 may undergo an update in any of a variety of ways, to represent a different or updated composition criterion. For example, the composition criterion data 118 may undergo a change in a datum (e.g., a change in a tag), addition of a datum (e.g., addition of a tag), or removal of a datum (e.g., removal of a tag), in any combination. As another example, the composition criterion data 118 may undergo a change in one or more rules. The matching participant identification module 112 may, in response to and/or based on one or more such updates, repeat operation 204, described above, to select, as a second matching set of participants, a second subset of the participants represented by the participant data 116, where each of the participants in the second subset has associated user metadata which satisfies the updated or new composition criterion represented by the composition criterion data 118. The matching participant identification module 112 may output an updated version of the matching participant data 120, representing the second subset of the participants represented by the composition criterion data 118. The matching participant data 120 may represent a plurality of participants, but fewer than all of the participants represented by the composition criterion data 118.

In this way, the matching participant identification module 112 may update the set of participants represented by the matching participant data 120 to reflect those participants whose associated user metadata satisfies the composition criterion represented by the composition criterion data 118, in light of the update(s) to the composition criterion data 118.

In any of the cases disclosed above (in which the user data 108a-n, user metadata 114a-n, participant data 116, and/or composition criterion data 118 undergo an update to produce an updated version of the matching participant data 120), the user data aggregation module 122 may generate an updated version of the composition output 124 by repeating operation 206, described above, in light of the updated version of the matching participant data 120. The system 100 may perform, in connection with that updated version of the composition output 124, any of the functions disclosed above in connection with the original version of the composition output 124, such as providing instances of the updated version of the composition output 124 to one or more of the user devices 106a-n. This may result, for example, in one or more of the users 102a-n seeing the audio/video streams of one or more participants being added to and/or removed from the compositions that are displayed by their corresponding user devices 106a-n.

In any of the cases described above, in which the matching participant identification module 112 updates the matching participant data 120 in response to one or more updates to the user data 108a-n, user metadata 114a-n, the participant data 116, and/or the composition criterion data 118, the resulting second (updated) subset of the participants may, for example:
be identical to the first (original) subset of the participants;
include one or more participants not included in the first subset of the participants; and/or
not include one or more participants included in the first subset of the participants.

The composition generation module 110 may, for example, perform any such updates to the matching participant data 120 and/or the composition output 124 automatically in response to a change in the user data 108a-n, user metadata 114a-n, participant data 116, and/or composition criterion data 118. The composition generation module 110 may perform such automatic updates to the matching participant data 120 and/or the composition output 124 any number of times to produce any number of updated versions of the matching participant data 120 and/or composition output 124.

Although some of the description above refers to a single set of composition criterion data 118 representing a single composition criterion, this is merely an example and does not constitute a limitation of the present invention. Alternatively, for example, the composition criterion data 118 may include a plurality of composition criteria of the kinds disclosed herein, such as distinct composition criterion data corresponding to each of a plurality of any one or more of the following, in any combination:
users 102a-n;
user devices 102a-n; and/or
events.

As merely one example, each of two or more participants represented by the participant data 116 may be associated with corresponding composition criteria represented by the composition criterion data. Different participants may be associated with composition criteria data that differ from each other in any of a variety of ways. For example, one participant's associated composition criterion data may specify a first set of tags, and another participant's associated composition criterion data may specify a second set of tags that differs from the first set of tags. For example, the first set of tags may include a tag that is not included in the second set of tags, and/or the second set of tags may include a tag that is not included in the first set of tags.

The composition generation module 110 may perform operation 204 for each such composition criterion in the plurality of composition criteria to generate a plurality of versions of the matching participant data 120, each of which corresponds to a distinct one of the plurality of composition criteria. Different versions of the matching participant data 120 may differ from each other in any of a variety of ways. For example, one version of the matching participant data 120 may represent at least one participant that is not represented by at least one other version of the matching participant data 120. The user data aggregation module 122 may perform operations 206 and 208 for each of the plurality of versions of the matching participant data 120 to generate a plurality of versions of the composition output 124, which may differ from each other in any of a variety of ways.

The composition generation module 110 may provide a plurality of versions and/or instances of the composition output 124 to some or all of the plurality of user devices 106a-n in any of a variety of ways. For example, the composition generation module 110 may provide:
two or more versions of the composition output 124 (e.g., two or more versions of the composition output 124 that were generated based on two or more versions of the matching participant data 120) contemporaneously to a single one of the user devices 106a-n;
one instance of one version of the composition output 124 to one of the user devices 106a-n contemporaneously with providing one or more instances of the same version of the composition output 124 to one or more other ones of the user devices 106a-n; and/or
one instance of one version of the composition output 124 to one of the user devices 106a-n contemporaneously with providing one instance of another version of the composition output 124 to another one of the user devices 106a-n.

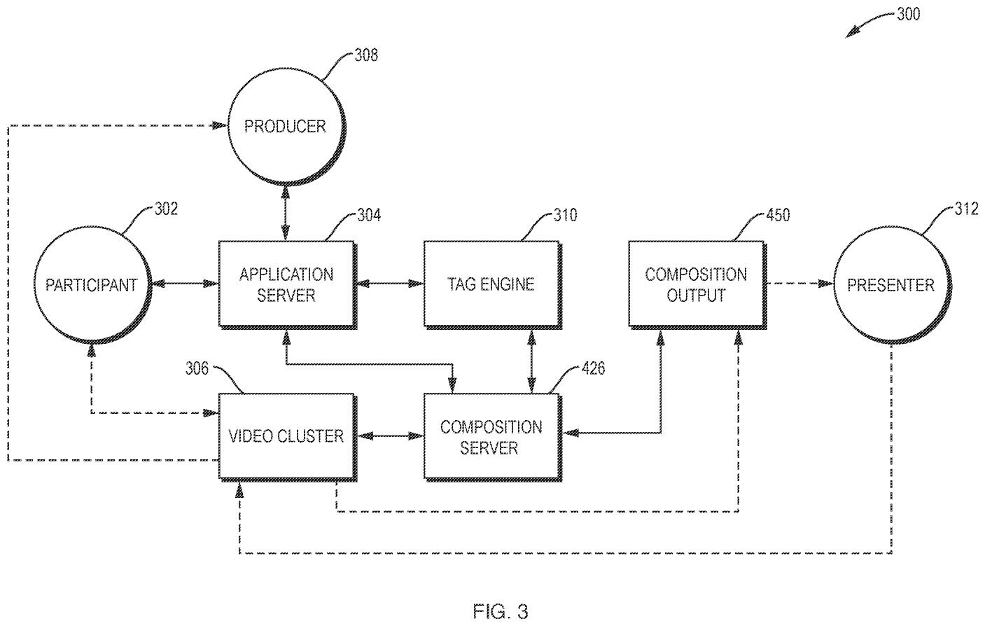

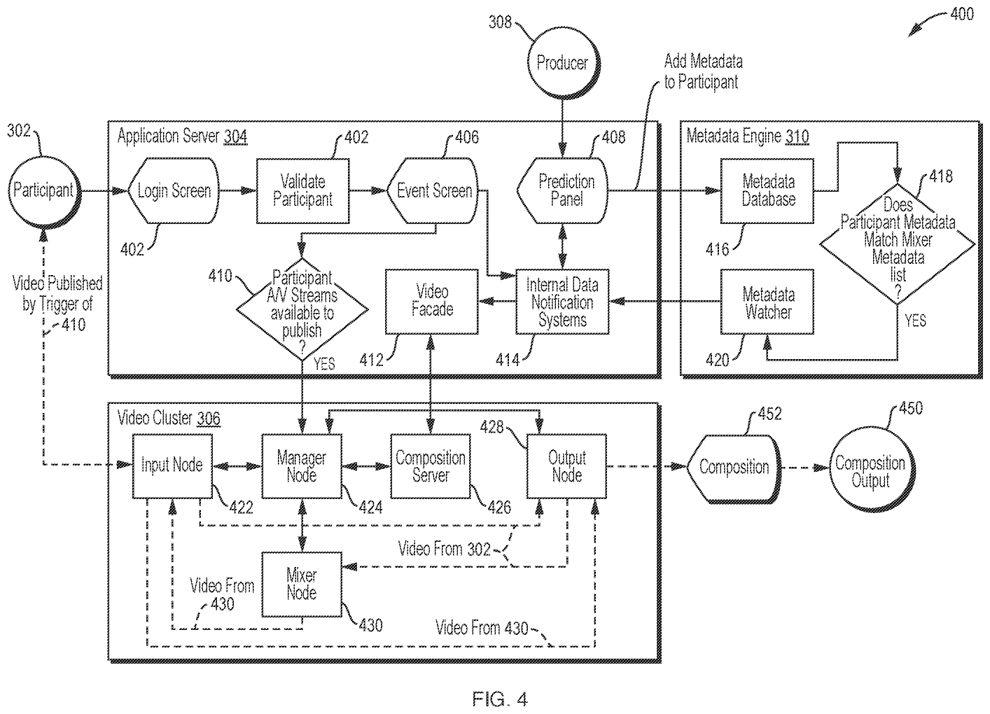

Referring to FIG. 3, a dataflow diagram is shown of an architecture of a composition generation system 300 according to one embodiment of the present invention. Referring to FIG. 4, a dataflow diagram is shown of components of the system 300 according to one embodiment of the present invention. Because FIG. 4 provides details about particular example implementations of the system 300 of FIG. 4, any reference herein to FIG. 3 should be understood to refer to FIG. 3 and/or FIG. 4, and any reference herein to FIG. 4 should be understood to refer to FIG. 3 and/or FIG. 4.

The system 300 of FIG. 3 includes a participant 302, who may be a human with access to computer hardware (referred to herein as “the participant 302's hardware”) including networking hardware for accessing the system of FIG. 1 over a network (e.g., the internet), a video camera, and (optionally) a microphone. The participant 302 is an example of any of the users 102a-n of FIG. 1, and the participant's hardware is an example of any of the user devices 106a-n of FIG. 2. As this implies, anything disclosed herein in connection with the participant 302 is equally applicable to a plurality of participants.

The participant 302's hardware (which may include, for example, one or more computing devices, such as a laptop computer, tablet computer, or mobile computing device) makes a connection to an application server 304. Any reference herein to functions performed by the participant 302 should be understood to refer to functions performed by the human participant 302 and/or the participant 302's hardware. The participant 302 may connect to the application server 304 over any type of network, such as a LAN or WAN (e.g., the Internet), via any type of network connection.

The participant 302 may provide, to the application server 304, event selection input indicating a particular event that the participant 302 wishes to join. As will be described in more detail below, the systems 300 and 400 of FIGS. 3 and 4, respectively, may enable the participant 302 and other participants to join any of a plurality of events. Different participants may join different events contemporaneously. The systems 300 and 400 may, for example, assign a distinct unique event identifier to each of the plurality of events. The event selection input provided by the participant 302 to the application server 304 may include one of the plurality of unique event identifiers and/or data that corresponds to one of the plurality of unique event identifiers, such as human-readable text that corresponds to one of the plurality of unique event identifiers. Regardless of the form that the event selection input takes, if the participant 302 successfully connects to the application server 304 as described below, the systems 300 and 400 may store data (referred to herein as “participant attendance data”) indicating that the participant 302 has joined and currently is attending the event represented by the event selection input provided by the participant 302. So long as the system 100 stores such data, the participant 302 is said to have “joined” that event, to be “in” that event, to be “attending” that event, and to be an “attendee” of that event. At a subsequent time, such as in response to receiving input from the participant 302 indicating a desire to leave that event or in response to that event ending, the systems 300 and 400 may store data indicating that the participant 302 has exited or otherwise no longer is attending that event.

At any particular point in time, the systems 300 and 400 may include participant attendance data for a plurality of participants, including the participant 302. Such participant attendance data may include, for example, for each of the plurality of participants, data indicating which event(s), if any, that participant currently is attending. Such data may take any of a variety of forms, such as: (1) a table mapping each of the plurality of participants to zero or more events currently being attended by those participants; and/or (2) a table mapping each of a plurality of events to zero or more participants who currently are attending those events. The systems 300 and 400 may update such participant attendance data over time as participants join and exit events.

In response to the participant 302 connecting to the application server 304, the application server 304 may require that the participant 302 be authenticated before the participant 302 is allowed to proceed further. Such authentication may be performed in any of a variety of ways, such as by requiring that the participant 302 provide login credentials (e.g., a username and password) and then validating those credentials before allowing the participant 302 to proceed further. For example, the system 400 may present as output a login screen 402, into which the participant 302 may enter login credentials (such as the participant 302's name and email address). The system 400 may validate 404 the participant 302 based on the provided credentials, such as by determining whether the email address provided by the participant 302 is contained within an existing list of registered email addresses. If the system 400 does not find the participant 302's email address, the system 400 may register the participant 302 as a new user of the system 400 by adding the participant 302's email address to the list of registered email addresses, and by storing the participant 302's name in association with that email address. In either case, the validation process then completes and the system 400 may provide as output an event screen 406. As will be described in more detail below, the system 400 may provide as output, within the event screen 406, the main audio and video streams for the participant 302 to view. When the participant 302 is viewing the event screen 406, the system 400 may also capture the participant 302's audio and/video streams and transmit them to the video cluster 306.

Once the participant 302 has connected to the application server 304 (and been validated, if required), the application server 304 may present the participant 302 with a user interface, such as via the event screen 406 mentioned above. For example, the participant 302's hardware may act as a client in relation to the application server 304. The application server 304 may provide output to the participant 302's hardware, which may in turn provide output (e.g., audio output and/or visual output) to the participant 302. The participant 302's hardware may receive input from the participant 302, such as by receiving such input through the user interface provided by the application server 304, and provide that input to the application server 304. In this way, the application server 304 may, through the participant 302's hardware, interact with the participant 302 via a user interface which provides output to the participant 302 and receives input from the participant 302. Any description herein of output that is provided to the participant 302 and of input that is received from the participant 302 may be implemented, for example, using such a user interface.

The connection between the participant 302 and the application server 304 may, for example, be a two-way websocket connection. This connection may be used to send, from the participant 302 to the application server 304, messages, such as user inputs provided by the participant 302 during the login (validation) process described above, and observed data (e.g., telemetry data, browser information, and metadata).

The systems 300 and 400 also include a producer 308 who, like the participant 302, may be a human user of the systems 300 and 400 who is connected to the systems 300 and 400 via corresponding producer hardware (which may, for example, be any of the hardware disclosed herein as examples of the participant 302's hardware). Everything said above about output provided to the participant 302 and input received from the participant 302 applies equally to output provided to the producer 308 and input received from the producer 308.

The application server 304 may include a web server, an API gateway, and a websocket server. The web server generates the user interfaces for the participant 302 and the producer 308. The API gateway is a management tool that sits between a client and the collection of backend services (reverse application proxy) that accepts API calls and returns responses. The websocket server is an application that listens for and/or sends messages on a TCP port.

The web server receives, as inputs, information from system users (e.g., the participant 302 and producer 308), such as user credentials, user AV device selection, and event selection details such as the particular event that a participant intends to join. The websocket server receives messages from participants (e.g., participant 302), producers (e.g., producer 308), the metadata engine 310, and the composition server 426 over two-way websocket connections. The API gateway receives API calls from the websocket server.

The web server receives and processes the user web markup language requests. The websocket server receives, processes and sends websocket messages specific to system and user activity. The API gateway receives and processes API requests.

The web server delivers, as outputs, the front-end user interface elements to the various users (e.g., the participant 302 and producer 308) to facilitate their activities, such as joining, viewing, interacting, and managing events. The websocket server processes messages and then routes messages as it has been programmed to do to other system components including users, producers, the API gateway, and tag engine. The API gateway returns API responses to the requests generated from Producer interactions with the system. In coordination, these components of the Application Server output event notification messages, which are rendered in the Producer interface.

Furthermore, in response to the system determining that the participant 302 has successfully logged into the system and that the participant 302 is accessing the event screen 406 from a computer that has a valid web camera and microphone (decision 410), the application server 304 directs the participant 302's hardware to create a stream with video and/or audio from the participant 302's camera and microphone to be sent to a video cluster 306. The video cluster 306 then waits for instructions from a composition server 426.

As will be described in more detail below, the composition server 426 generates and updates compositions, such as the composition 452, which is an example of the composition output 124 of FIG. 1. A composition may, for example, include a composited audio and/or video stream which is associated with a particular event, and which includes the audio and/or video streams of a set (e.g., one or a plurality) of participants who have been assigned by the system to be displayed to a user (e.g., a participant, producer, or presenter) at a particular time and in a particular layout. For example, consider a particular event being attended by one hundred participants. One composition associated with that event at a particular time may include 25 of those participants, arranged in a 5×5 grid, with each of the 25 participants being assigned a particular corresponding position within the grid. As this example illustrates, a composition associated with an event may include a proper subset (i.e., fewer than all) of the users currently attending the event.

The system 400 may generate, as output, a composition 452 associated with a particular event. The composition 452 may, for example, include audio and/or video output, and/or data that may be used to generate audio and/or video output. The composition 452 may, for example, be received by one or more output devices (such as one or more of the user devices 106a) and/or one or more software applications (e.g., web browsers), which may generate, based on the composition 452, composition output 450. The composition output 450 may, for example, be rendered audio and/or video output that is generated based on the composition 452. As one particular example, the video cluster 306 may transmit the composition 452 over a network to one of the user devices 106a, which may execute a web browser, which may generate, based on the composition 452, audio and/or video output in the form of the composition output 450. Although the composition 452 and composition output 450 are shown as distinct elements in FIG. 4, the composition 452 and/or composition output 450 may be combined together and/or further subdivided into additional outputs in any of a variety of ways. As a result, those having ordinary skill in the art will appreciate that references to the composition 452 herein may be equally applicable to the composition output 450, and vice versa.

The system 400 may provide the composition output 450 to one or more users (e.g., participants, producers, and presenters) of the system 400 who currently are associated with that event. A particular composition (e.g., the composition 452) may be associated with one or more (e.g., all) of the users of the system 400. The association between a composition and its associated users may be defined in any of a variety of ways. For example, the data that specifies the users who are associated with a particular composition may specify any one or more of the following, in any combination:
a particular enumerated set of users, in which case the particular composition is associated with that particular enumerated set of users (or the subset of those users who currently are attending the event associated with the composition); and
metadata (e.g., one or more tags), in which case the particular composition may be associated with all or a subset of the users having the specified metadata and who currently are attending the event associated with the particular composition.

The system 400 may provide composition output 450 representing a composition only to the user(s) associated with that composition, and not to other users of the system 400. For example, if a particular composition is associated with a particular event and with a particular presenter 312 who is currently attending that particular event, then the system 400 may provide output representing the composition only to that presenter 312 and not to other users of the system 400, such as to other presenters or to any producers or participants of the system 400. As another example, if a particular composition is associated a particular event and with the role of presenter, then the system 400 may provide composition output 450 representing the composition only to all presenters who currently are associated with (e.g., attending) that particular event, but not to other users of the system 400 (e.g., participants and producers associated with that particular event).

A plurality of compositions may be associated with a particular event concurrently. Each of the plurality of compositions may have its own set of associated participants. The set of users who are associated with any particular composition at a particular time may differ from the set of users who are associated with any other particular composition at that particular time. As a result, at any particular time, the system 400 may provide first output representing a first composition to a first set of users associated with a particular event, and provide second output representing a second composition to a second set of users associated with the particular event, where the first composition may differ from the second composition, and where the first set of users may differ from the second set of users. As a concrete example, at a particular time, the system 400 may display (e.g., on a first monitor) a 3×3 grid of a first set of users to a Producer of a particular event and display (e.g., on a second monitor) a 10×10 grid of a second set of users to a Presenter of that same particular event, where the first set of users differs from the second set of users (even though there may be some overlap between the first and second sets of users).

Furthermore, and as will become clear from the description below, the system 400 may repeatedly and automatically update some or all such compositions over time in response to events such as users joining and exiting events, metadata (e.g., tags) being assigned to and unassigned from users, and the definitions of compositions changing. In response to a particular composition changing (such as in response to a user being added to or removed from a composition), the system 400 may update the output representing that composition to reflect the change(s) in the composition. As a concrete example, if a particular composition associated with a particular event and a particular presenter associated with that particular event has a particular set of participants arranged in a 3×3 grid at a particular time, then the system may display the audio/video streams of that particular set of participants to the presenter 312 in a 3×3 grid at that particular time. If one of those participants exits the particular event, the system 400 may, in response to that exit, update the composition to omit the participant who exited the meeting and stop outputting that participant's audio/video stream to the presenter 312. Furthermore, the system 400 may, in response to that exit, automatically select another participant, add that participant to the composition, and display that participant's audio/video stream to the presenter 312. As a particular example, if the composition is associated with a particular tag, the system 400 may, in response to the exit of the previous participant, identify a participant who: (1) currently is attending the event associated with the composition; (2) is associated with the particular tag; and (3) is not currently associated with the composition, and add that identified participant's output audio/video stream(s) to the composition. The system 400 may then display the newly-added participant's audio/video stream to the presenter 312 within that composition. The end result, from the presenter 312's perspective, is to see the exited participant's audio/video stream disappear from the 3×3 grid and to see the newly-added participant's audio/video stream appear in the 3×3 grid.

Although only one participant 302 is shown in FIG. 3 for ease of illustration, it should be understood that the system of FIG. 3 may include a plurality of participants, including the participant 302. Any disclosure herein of functions performed by, or in connection with, the participant 302, should be understood to include disclosure of those functions by, or in connection with, a plurality of participants, including the participant 302. There is no limit to the number of such participants. For example, embodiments of the system 300 of FIG. 3 may be used in connection with compositions including at least 1, 4, 9, 16, 25, 36, 49, 64, 81, 100, 121, 144, 169, 196, 225, 256, 289, 324, 361, 400, 441, 484, 529, 576, 625, 676, 729, 784, 841, 900, 961, 1024, 1089, 1156, 1225, 1296, 1369, 1444, 1521, 1600, 1681, 1764, 1849, 1936, 2025, 2116, 2209, 2304, 2401, 2500, or 30,000 participants, including the participant 302. Specific non-limiting examples of numbers of participants in compositions are 9 (i.e., in a composition having a 3×3 grid), 16 (i.e., in a composition having a 4×4 grid), 25 (i.e., in a composition having a 5×5 grid), 36 (i.e., in a composition having a 6×6 grid), 49 (i.e., in a composition having a 7×7 grid), 64 (i.e., in a composition having an 8×8 grid), 81 (i.e., in a composition having a 9×9 grid), and 100 (i.e., in a composition having a 10×10 grid). More generally, in cases in which the composition has a square grid layout, the number of participants in the composition may be n², wherein n is the width and height of the grid and may be any number.

The producer 308 is a person who connects to the system 300 of FIG. 3 and who operates and administers the system 300 during live events. Once authenticated for a specific event, the producer 308 interacts within a dedicated producer user interface that connects to the application server 304 via two way websocket and API connections. Within the producer user interface, the producer 308 may be presented with information and take various actions such as to start, view, update, edit, and delete events, compositions, users, metadata (e.g., tags), and other elements. Although only one producer 308 is shown in FIGS. 3 and 4 for ease of illustration, the systems 300 and 400 of FIGS. 3 and 4, respectively, may include any number of producers. Therefore, any reference herein to the producer 308 should be understood to refer to one or more producers.

The producer 308 makes a connection to the application server 304. Any reference herein to functions performed by the producer 308 should be understood to refer to functions performed by the human producer 308 and/or the producer 308's hardware. The producer 308's hardware may, for example, be any of the types of hardware disclosed herein in connection with the participant 302's hardware. The producer 308 may connect to the application server 304 over any type of network, such as a LAN or WAN (e.g., the Internet), via any type of network connection. The producer 308 may connect to the application server 304 in any of the ways disclosed herein in connection with the participant 302.

Once the producer 308 has successfully connected to the application server 304, the system may (via the producer 308's hardware) present the producer 308 with a user interface in the form of a production panel 408. The production panel 408 is the main user interface that the producer 308 interacts with to administer an event, including compositions associated with that event. The production panel 408 communications with the internal data notification system (IDNS) 414 in order to communicate with the rest of the system 400. The production panel 408 contains realtime data for all currently created compositions, actively connected participants, and the list of currently applied metadata (e.g., tags).

The production panel 408 may be used by the producer 308 to manually inspect a participant (e.g., participant 302) in order to view the metadata (e.g., tags) that are currently applied to that participant and to manually edit (e.g., add or remove) metadata from that participant. Such edits to metadata, and any other changes made by the producer 308 using the production panel 408, are communicated to the IDNS 414 and/or directly to the metadata engine 310. Such data may be updated in real time via WebSocket notifications and periodic RESTful API calls to the metadata engine 310 and the IDNS 260. A video façade 412 is a server that translates the subscribed messages from the IDNS 414 and sends RESTful API calls and WebSocket messages to the video cluster 306, such as the composition server 426 in particular.

The Internal Data Notification System (IDNS) 414 may, for example, be a message-oriented middleware system using a publish-subscribe paradigm. The IDNS 414 may send and receive messages between various parts of the application server 304 and the metadata engine 310 to enable interaction between them without requiring either such component to understand one another.

The application server 304 may send to the producer 308 data on all connected resources in the system 400, including the participant 302 and any other participants. The producer 308 sends commands to the application server 304, which in turn communicates with a metadata engine 310. The metadata engine 310 notifies the composition server 426 of any changes in metadata state (add, updation, or remove) in relation to each connected user (e.g., participant). Once the composition server 426 has been notified of these changes, it communicates with the video cluster 306 to create or affect an output stream or streams, which is provided to a web browser (not shown in FIG. 1). The web browser generates, based on the output stream(s), composition output 450 representing the output stream(s). The composition output 450 is output (e.g., by one or more display devices and one or more speakers) to the presenter(s) 312.

After the participant 302 begins publishing the participant 302's user output (e.g., audio and/or video stream, labeled in FIG. 4 as “Video published by trigger of 410”), the producer 308 connects to the production panel 408 and applies metadata (e.g., a tag) to the newly joined participant 302. The producer 308 may, for example, manually select the metadata to be applied to the participant 302. Alternatively, for example, the system 400 may automatically select the metadata to be applied to the participant 302. One way the system 400 may automatically select the metadata applied to the participant 302 is by using the metadata engine 310. One such example of the metadata engine 310 applying metadata (e.g., a tag) automatically would be the tag “USA” if the participant 302 is in the United States and the metadata engine 310 has received telemetry data to signal this. The system 400 may apply the same or different metadata to a plurality of participants. Although the description herein refers to applying a single unit of metadata (e.g., a single tag) to the participant 302, more generally the system 400 may apply any number of units of metadata to the participant 302, and to any of the participants in the system 400. Therefore, any reference herein to “the participant 302's metadata” should be understood to refer to one or more units of metadata applied to the participant 302.

Regardless of how the participant 302's metadata is selected, the metadata engine 310 applies the selected metadata to the participant 302. “Applying” the metadata to the participant 302 includes the metadata engine 310 storing the participant 302's tag in the metadata database 416 in any way that associates the metadata with the participant 302, such as by storing the metadata in a record associated with the participant 302 or storing an identifier of the participant 302 in association with the metadata.

More generally, the metadata engine 310 may be a server cluster that contains the databases and servers that store, apply, and perform actions based on the addition, removal, and updation of metadata in the metadata database 416. The metadata database 416 may be a cluster of servers that write incoming changes and store them for analysis by a metadata watcher 420. The metadata watcher 420 may be a server that watches for any type of change, addition, or deletion of metadata in the metadata database 416. Based on such changes, preprogrammed actions may be performed via notification of the IDNS 414.

The metadata engine 310 applies metadata to and removes metadata from records associated with participants (by updating the metadata database 416 accordingly), and triggers functions related to the existence and status of that metadata. The metadata engine 310 enables data-based sorting, filtering, isolating, and grouping of user audio/video streams, such as the audio/video stream published by the participant 302 and other participants. The metadata engine 310 may include a sub-component in the form of an event handler and interpreter, which instructs the composition server 426, via websocket, SNS, or API to create, update, and delete compositions. The metadata engine 310 receives requests from the application server 304 and the composition server 426 to make changes to tags in the metadata database 416, such as adding, deleting, and updating metadata. In response, the metadata engine 310 makes the requested changes to the metadata in the metadata database 416.

The metadata engine 310 may include or otherwise implement rules. Such rules may be triggered by the addition, removal, or updation of metadata within the metadata database 416. Each such rule has an associated action. In response to the metadata engine 310 determining that a particular one of the rules has been triggered by the addition, removal, or updation of metadata in the metadata database 416, the metadata engine 310 may perform the action associated with the particular one of the rules, such as by the metadata engine 310 sending a request to the composition server 426 and/or the application server 304 to perform the action.

A mixer node 430 stores one or more lists of tags. Each such list includes a set (i.e., one or more units) of metadata associated with a particular composition. As described in more detail below, for each composition, the systems 300 and 400 of FIGS. 3 and 4 may: (1) identify participants whose metadata match the metadata in the metadata list associated with that composition, and add the user data from the identified participants to that composition; and (2) identify participants whose metadata do not match the metadata in the metadata list associated with that composition, and remove the identified participants from that composition. The systems 300 and 400 of FIGS. 3 and 4 may perform these steps repeatedly over time, and thereby add and remove participants from a composition repeatedly over time, as participants join and leave events, as the metadata (e.g., tags) associated with participants within the systems 300 and 400 change, and as the metadata in the lists maintained by the mixer node 430 change.

The mixer node 430 is part of the video cluster 306, which is a system that ingests and outputs audio/video streams. One function performed by the video cluster 306 is to aggregate the audio/video sources (e.g., the video published by the participant 302 and other participants) and other user data, so that they are available to the system 400 individually and in any combination desired. The video cluster 306 includes a manager node 424, which gives direction to all of the nodes inside the video cluster 306. The manager node 424 receives RESTful API and WebSocket messages from the composition server 426 to know which streams to publish to what mixer node 430 or output node 428. The manager node 424 also controls the auto-scaling of resources inside the video cluster 306.

The video cluster 306 may be connected via a two-way webRTC channel to a user interface, via an incoming (webRTC/RTMP) connection from the production feed from the stage/venue, and via outgoing webRTC connections to the composition output 450 and producer 308. The video cluster 306 shares a two-way websocket and RESTful API connection to the composition server 426. The participant 302's audio/video stream is received by an input node 422 in the video cluster 306. The input node 422 is the ingress for incoming video streams from the participant 302 and other participants, and from the presenter 312 and other presenters. Any element that outputs video that needs to be available inside the video cluster 306 may first have that video ingested into the input node 422. This includes video that is output by the mixer node 430, even though the mixer node 430 is already inside the video cluster 306.

The input node 422 may receive video via WebRTC or RTMP protocols. The input node 422 may output video to the output node 428. The output node 428 is responsible for egress of video and audio streams from the video cluster 306. Any stream that needs to be accessible inside the video cluster 306 must come from an output node 428.

Users (e.g., the participant 302 and other participants, and the producer 308 and other producers) may connect to the video cluster 306 via a two-way webRTC connection and a two-way websocket connection. These connections may be used to send, from the users to the video cluster 306, unique identifiers (e.g., of the event that they are joining), their audio/video streams, and user intent messages. The video cluster 306 receives, as inputs, audio/video streams from users (e.g., the participant 302 and other participants, and the producer 308 and other producers) and audio/video streams and/or feeds from the stage/venue/control room/encoders at the stage or other location of the producer 308 or other producers. The video cluster 306 receives websocket messages and RESTful API calls from the composition server 426 (with requests for various audio/video streams).

The video cluster 306 (stores, stages, and/or holds) audio/video streams and feeds, renders multiple streams together, and makes individual and rendered streams available as outputs. The video cluster 306 outputs audio/video streams to the producer 308 as requested. It outputs data in the form of websocket messages to the composition server 426 with indications of video cluster statuses.

Returning to the case in which the participant 302 has joined the system 300, and in which the participant 302's metadata (e.g., tags) have been added to the metadata database 416, the metadata watcher 420 detects that new metadata (i.e., the metadata applied to the participant 302) has been stored in the metadata database 416. In response to detecting that this newly applied metadata matches a list from the mixer node 430 (step 330), the metadata watcher 420 notifies the IDNS 414 of the match. The IDNS 414 notifies both the production panel 408 and the video façade 412 to add the participant 302 to the composition that corresponds to the list in which the match was found. The video façade 412 notifies the composition server 426 to add the participant 302 to that composition. The composition server 426 notifies the manager node 424 to start the process of the selected mixer node 430 subscribing to the video stream of the participant 302. The mixer node 430 publishes its video to the composition 452.

In general, the system 300 may provide the composition output 450 as output, on one or more display devices, to one or more of the presenters 312. The composition output 450 may represent the current composition. The system 300 may dynamically update the composition output 450 to reflect changes to the composition as the composition changes. For example, if the system 300 removes a participant (e.g., participant 302) from the composition, the system 300 may update the composition output 450 to remove that participant's user data (e.g., audio/video stream) from the composition output 450. Similarly, if the system 300 adds a participant to the composition, the system 300 may update the composition output 450 to add that participant's user data (e.g., audio/video stream) to the composition output 450. The system 300 may make such changes to the composition output 450 repeatedly and automatically, such as in response to changes in the metadata database 416 and/or to participants joining and/or leaving one or more events.

The composition output 450 may be provided to the presenter(s) in any of a variety of physical forms. For example, the system 300 may display, in the composition output 450, the remote participants within a particular composition to a presenter:
In front of the presenter as an audience.
Surrounding the presenter in a studio as an entirely virtual audience.
On a plurality of screens arranged linearly, e.g., lining a red carpet.
On a plurality of screens flanking a concert stage.

The composition server 426 parses commands from the metadata engine 310 and affects the changes on the video cluster 306 while relaying status updates to the application server 304 and composition output 450. The composition server 426 receives RESTful API calls and WebSocket messages as inputs. The composition server 426 outputs RESTful API calls and WebSocket messages. Under normal operation, the composition server 426 gets the status of the video cluster 306 and receives instructions via RESTful API or WebSocket messages to use create, read, update, and delete functions inside the video cluster 306.

The composition output 450 may, for example, be output, produced by a web browser on an internet-connected computing device, when the web browser has browsed to a specific URL associated with the composition generation systems 300 and 400 of FIGS. 3 and 4. The composition output 450 may include, for example, streaming media from the video cluster 306. The composition output 450 may be provided, for example, via HDMI or other hardware video connectors on the computer to be integrated into a video production environment. The composition output 450 may be fed a stream that it subscribes to as an input for the browser window. Once composition output 450 is opened and active, it may display a live video stream of a composition.

The presenter 312 may, for example, be located at any location at which the presenter 312 physically presents from. Although the term “stage” is used herein to refer to that location, the presenter 312 may, but need not, be or include a stage. For example, the presenter 312 may be or include a room, a podium, or a field. More generally, any location that includes the equipment required to capture a video and/or audio stream of the presenter 312 and to provide that audio/video stream of the presenter 312 to the event wall display system may be the presenter 312. The presenter 312 may be one of the end points opposite of the participant 302.

The presenter 312 may receive composition audio and/or video streams that are displayed via composition output 450 by connecting to any digital display surface, such as a TV, monitor, projector, or LED video wall.

The presenter 312 may display one or more compositions at any time. Audio sent from the video cluster 306 may be outputted from a version of the composition output 450 called “The Audio Conference”. This allows for proper separation and handling of audio so that any participants that speak do not hear themselves fed back to their own speakers. The audio from the Audio Conference version of the composition output 450 may be mixed in with the audio from Presenter and included in the return stream (Via RTMP or WebRTC) back to the video cluster 306 for all other Participants to consume.

The presenter 312 may send an audio and/or video stream via RTMP or WebRTC to the video cluster 306, which may be the final audio/video stream that the participant 302 consumes.

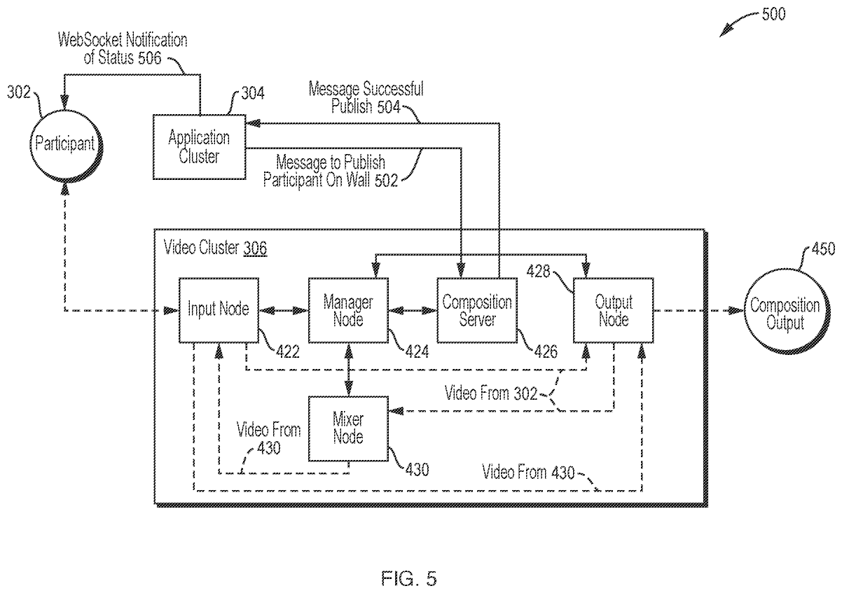

Various embodiments of the present invention may be used to generate output, referred to herein as “composition status output,” representing the status of one or more participants associated with a particular event and/or composition. Referring to FIG. 5, a dataflow diagram is shown of a system 500 for generating composition status output according to one embodiment of the present invention. The composition status output may be within the composition output 450.

In general, the system 500 may generate one or more composition status outputs corresponding to the participant 302 based on, for example, some or all of the user metadata 114a-n that corresponds to the participant 302. Such user metadata may include, for example, one or more statuses of the participant 302 within an event that the participant 302 currently is attending. One example of such a status is a “Live Content” status, which may have a value of “True” or “False.” The system 500 may change the value of the participant 302's “Live Content” status to “True” if and when the system 500 is outputting (e.g., displaying video and/or playing audio) “live content” to the participant 302 in the composition output 450 that is provided to the participant 302, e.g., content happening in real-time with a delay of less than 5 seconds from the presenter 312 and/or other participant(s). Otherwise, the system 500 may change the value of the participant 302's “Live Content” status to “False.”

As another example, the participant 302 may have an “Interactive” status, which may have a value of “True” (which indicates that the participant 302 is able to interact with the presenter 312 or the event that the participant 302 is attending) or “False” (which indicates that the participant 302 not able to interact with the presenter 312 or the event that the participant 302 is attending).

As described in more detail below, the system 500 may generate and output, within the composition output 450, a composition status indicator which represents the current value of the participant's 302 “Live Content” indicator, such as by displaying the word “LIVE” to the participant 302 if the participant 302's “Live Status” indicator has a value of “True,” and displaying the word “NOT LIVE” if the participant 302's “Live Status” indicator has a value of “False.”

The particular examples of composition status indicators provided above are merely examples and not limitations of the present invention. Any suitable indicator(s) may be used to provide output representing any composition status of the participant 302. A composition status indicator may, for example, be or include any one or more of the following, in any combination: (1) text; (2) color; (3) one or more icons; (3) one or more images; (4) one or more videos; and (5) audio.

Certain composition statuses may take the form of parameters having Boolean values. For example, the “Live Content” status may have a Boolean value, e.g., true or false. In such a case, the system may provide output representing one Boolean value of the parameter (e.g., true) by affirmatively providing output representing that value to the participant 302 (e.g., “Live”) and may provide output representing the other Boolean value of the parameter (e.g., false) by affirmatively providing output representing that value to the participant 302 (e.g., “Not Live”). As another example, the system may provide output representing one Boolean value of the parameter (e.g., true) by affirmatively providing output representing that value to the participant 302 (e.g., “Live”) and may indicate that the parameter has the other Boolean value (e.g., false) by not providing any output to the participant 302 (e.g., by leaving blank a space in which “Live” would be output if the value of the parameter were true).

In the description that follows, the participant 302 has a single composition status and corresponding composition status indicator, for the sake of example. When the participant 302 joins an event by connecting to the application server 304, the participant 302 may be connected to the video cluster 306, which begins providing an audio/video stream to the participant 302. The participant 302 may also publish video back into the video cluster 306, which the video cluster 306 may in turn output within the composition output 450.

When the participant 302's hardware begins displaying real time audio/video stream content, the system 500 may set and display the participant 302's composition status indicator to a value of “Live,” and may continue to do so for as long as the participant 302's hardware is displaying real time audio/video stream content.

When the participant 302 has been selected, either manually, or automatically through a rule or automation based on tags, metadata, and/or other system process, and is being actively displayed in the composition output 450, the system may set and display the participant 302's composition status indicator as “Active,” and may continue to do so for as long as the participant 302 is being actively displayed in the composition output 450.

When the participant 302 has been selected, either manually, or automatically through a rule or automation based on tags, metadata, and/or other system process, and is actively displayed in the composition output 450 or other full screen display with the ability to have two-way audio communication, the system 400 may set and display the participant 302's composition status indicator to a value of “Interactive,” and may continue to do so for as long as the participant 302 is actively displayed in the composition output 450 or other full screen display with the ability to have two-way audio communication.

To trigger the “Active” or “Interactive” composition status values, the composition server 426 may send a message to the application server 304 each time participant 302 changes their publishing status. For example, when the participant 302 first connects to the video cluster 306, the composition server 426 may send a message to the application server 304 to acknowledge the successful connection of the participant 302's video stream. This message (line 504 in FIG. 5) may be the response to line 502. The message that triggers the state change in the user interface of the participant 302 is line 506 in FIG. 5, which may be a WebSocket message that sets the status.

The description above of the system 500 of FIG. 5 in relation to the participant 302 is applicable equally to any additional number of participants. As this implies, each of a plurality of participants may have a corresponding composition status. The statuses of such participants may be the same as or differ from each other, in any combination. For example, if a plurality of participants currently are attending a particular event, a first one of the plurality of participants may have a first composition status (e.g., “Active”) and a second one of the plurality of participants may concurrently have a second composition status (e.g., “Inactive”).

Although the description of FIG. 4 refers to outputting composition status indicators to the participants corresponding to those composition status indicators, embodiments of the present invention may, additionally or alternatively, output event wall participation status indicators to users having other roles, such as producers (e.g., producer 308) and presenters. The system 500 may output a plurality of composition status indicators, representing composition statuses of a plurality of participants, concurrently to a single user (e.g., a producer or presenter). Such a plurality of composition status indicators may concurrently include composition status indicators having varying values, such as both “Active” and “Inactive” composition status indicators.

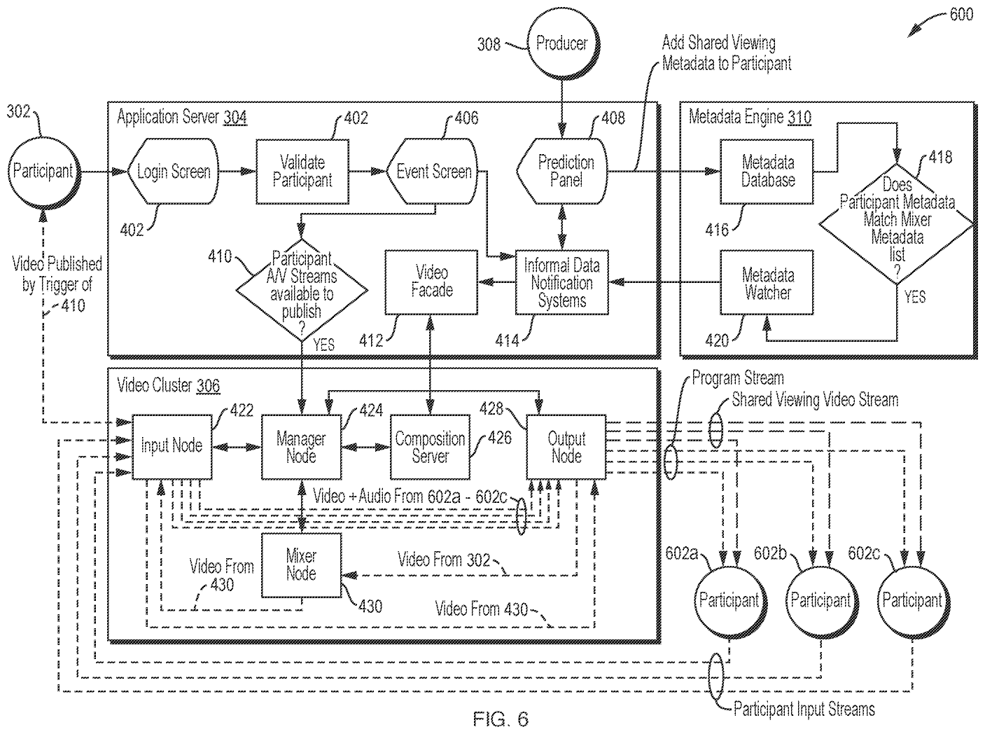

Referring to FIG. 6, a dataflow diagram is shown of a system 600 for allowing a plurality of participants attending a particular event to watch the main program stream while concurrently communicating with other participants attending that particular event via video and/or audio. For example, if a plurality of participants are attending a particular event concurrently, the system 600 of FIG. 6 may enable a proper subset (i.e., some, but fewer than all) of the plurality of participants to communicate with each other via video and/or audio, while still attending that particular event with other participants with whom they are not in audio and/or video communication.

The participant 302 may join an event in the system 600 of FIG. 6 in the same way as that described above in connection with FIGS. 1 and 2. In response to the addition of metadata applied to a participant record in the metadata database 416, the video cluster 306 may make audio/video streams for other selected participants available for the participant 302 to subscribe to, and display in the participant 302's event screen 406.

The set of “shared participants” may be selected and identified by the metadata engine 310. This may be done, for example, via an automated system that matches a plurality of participants together, manually by matching participants, or by an uploaded/predefined list of matches of participants. In any of these cases, the set of shared participants may constitute a proper subset of the participants who are attending an event.

For example, in addition to each participant subscribing to the program video stream, participants may also subscribe to all connected “shared participants”, e.g.:
participant 302 may subscribe to the audio/video of participants 602a-c;
participant 602a may subscribe to the audio/video of participant 302, 602b, and 602c;
participant 602b may subscribe to the audio/video of participant 302, 602a, and 602c; and
participant 602c may subscribe to the audio/video of participant 302, 602a, and 602b.

The use of four shared participants in FIG. 6 (i.e., participants 302 and 602a-c) is merely an example and does not constitute a limitation of the present invention. There may be any number of shared participants, and such number may change over time. The techniques disclosed herein may be applied to a plurality of groups of shared participants sequentially or contemporaneously, where those groups may be disjoint or overlap to any degree.

The lines labeled as “share viewing video streams” in FIG. 6 illustrate individual streams of audio/video that are being subscribed to by other participants. The lines labeled as “program stream” in FIG. 6 illustrate the main program feed coming from the presenter/stage that each of the participants 602a-c is subscribing to. The lines labeled as “participant input streams” in FIG. 6 illustrate the streams from the participant 602a-c's camera and microphone from their hardware into the video cluster 306.

One problem with existing online events is that presenters rely on audio feedback from participants. During in-person events, this includes both socialized audio feedback (e.g., clapping, laughing, and cheering) and individualized audio feedback (e.g., callouts and questions). In contrast, in conventional online events, audio feeds from remote participants are inherently individualized; there is no socialized audio (i.e., audio from a plurality of participants) because each participant is in a distinct location and provides audio through a distinct audio feed. This results in audio feedback that is perceived by presenters as unnatural.

Embodiments of the present invention address this problem by aggregating individual audio feeds from individual participants, and optionally filtering and/or manipulating such aggregated audio feeds in order to provide socialized audio feedback to participants (e.g., presenters). The individual audio feeds to be aggregated may, for example, be selected based on any criterion, such as any of the composition criteria disclosed herein. Media sources (such as applause tracks) may be played at various intensities based on user actions (e.g., clicking a “clap” button) or other representations.

More specifically, embodiments of the present invention may identify a first participant selection criterion which may, for example, be any of the composition criteria disclosed herein. For example, the first participant selection criterion may specify a particular tag or set of tags. Embodiments of the present invention may select, as a first aggregated set of participants, a first subset of the plurality of participants represented by the participant data 116, where each of the participants in the first subset of the plurality of participants represented by the participant data 116 has associated user metadata which satisfies the first participant selection criterion.

The first aggregated set of participants may consist of a plurality of participants, but fewer than all of the participants represented by the participant data 116. Alternatively, the first aggregated set of participants may consist of all of the participants represented by the participant data 116.

Alternatively, instead of selecting the first aggregated set of participants from the plurality of participants represented by the participant data 116 (e.g., all of the participants in a particular meeting), embodiments of the present invention may select the first aggregated set of participants from the plurality of participants represented by the matching participant data 120 (e.g., from the participants whose user data are reflected in the composition output 124).

The first aggregated set of participants may consist of a plurality of participants, but fewer than all of the participants represented by the matching participant data 120. Alternatively, the first aggregated set of participants may consist of all of the participants represented by the matching participant data 120.

Embodiments of the present invention may aggregate audio streams (e.g., within the user data 108a-n) from the first aggregated set of participants into a first aggregated audio stream. Embodiments of the present invention may provide the first aggregated audio stream within the composition output 124, instead of providing the (individual) audio streams from the first aggregated set of participants. Since the matching participant data 120 may represent one or more participants who are within the first aggregated set of participants, and one or more participants who are not within the first aggregated set of participants, the above implies that the user data aggregation module 122 may include, within the composition output 124 both: (1) one or more individual audio streams from one or more users who are not within the first aggregated set of participants; and (2) the first aggregated audio stream.

Alternatively, for example, instead of providing the first aggregated audio stream within the composition output 124, embodiments of the present invention may exclude (not provide) the first aggregated audio stream, or the individual audio streams from which the first aggregated audio stream was derived, within the composition output 124. The effect of this is to mute, within the composition output 124, the audio streams of the participants within the first aggregated set of participants.

Embodiments of the present invention may apply one or more filters and/or effects of any kind(s) to the first aggregated audio stream, and any of the techniques disclosed herein may be applied to the first aggregated audio stream with the filter(s)/effect(s) applied to it.

Embodiments of the present invention may select and apply a particular volume to the first aggregated audio stream. That volume may, for example, be different from (e.g., greater than or less than) the volume that is applied to at least one other audio stream within the composition output (e.g., an audio stream from an individual participant). As this implies, different audio streams within the composition output 124 may have different volumes.

Any of the techniques disclosed above in connection with the first participant selection criterion may be repeated for any number of additional participant selection criteria. For example, there may be a second participant selection criterion, which may differ from the first participant selection criterion. For example, the first participant selection criterion may specify a first tag, and the second participant selection criterion may specify a second tag that is different from the first tag. Embodiments of the present invention may select, as a second aggregated set of participants, a second subset of the plurality of participants represented by the participant data 116 (or of the plurality of participants represented by the matching participant data 120), where each of the participants in the second subset has associated user metadata which satisfies the second participant selection criterion. The second aggregated set of participants may differ from the first aggregated set of participants. For example, the first aggregated set of participants may include a participant who is not included in the second aggregated set of participants, or vice versa.

Embodiments of the present invention may aggregate audio streams (e.g., within the user data 108a-n) from the second aggregated set of participants into a second aggregated audio stream. Embodiments of the present invention may provide the second aggregated audio stream within the composition output 124, instead of providing the (individual) audio streams from the second aggregated set of participants, and in addition to providing the first aggregated audio stream within the composition output 124. The above implies that the user data aggregation module 122 may include, within the composition output 124 both: (1) one or more individual audio streams from one or more users who are not within the first aggregated set of participants or the second aggregated set of participants; (2) the first aggregated audio stream; and (2) the second aggregated audio stream.

Embodiments of the present invention may also apply filter(s), effect(s), and a volume to the second aggregated audio stream, and any of the techniques disclosed herein may be applied to the second aggregated audio stream with the filter(s), effect(s), and/or volume applied to it. The filter(s)/effect(s) that are applied to the first aggregated audio stream may differ from the filter(s)/effect(s) that are applied to the second aggregated audio stream. The volume that is applied to the first aggregated audio stream may differ from the volume that is applied to the second aggregated audio stream.

Even during in-person live events, it is difficult for presenters to clearly see, identify, and quickly prompt interaction with an attendee. Even more so, presenters interacting with a composition of the kind generated by the system 100 of FIG. 1 may not have a way to quickly and accurately call for or prompt interaction with a specific participant if that specific participant cannot be uniquely identified or differentiated, especially if the number of participants is large, and/or if the participants' existing identifiers (e.g., real names) are common (e.g., “John”) or duplicative (e.g., multiple participants with the name “Sarah” within a single composition).

Embodiments of the present invention address this problem by automatically generating, for each of some or all of the participants represented within the composition output 124, a corresponding unique identifier. Embodiments of the present invention may display the unique identifier of each such participant within the composition output 124, such as by overlaying that unique identifier over the corresponding participant's video stream or by displaying that unique identifier near (e.g., adjacent to) the corresponding participant's video stream. As a result, the composition output 124 includes, for each of some or all of the participants represented within the composition output 124, a corresponding visual representation of a unique identifier.

As a result, the presenter 312 and/or other participants can easily see the unique identifier of each of some or all of the participants represented in the composition output 124. The presenter 312 and/or other participants may then call out (e.g., verbally or in writing) any participant unambiguously by referring to that participant's unique identifier. Because the composition instance displayed to each participant may also display that participant's (and other participant's) unique identifier, that participant can quickly determine and know that the presenter (or other participant) has called out that participant. This not only increases the speed with which participants may be identified and called out, but also decrease or eliminate the likelihood that any of the participants will be unsure about which participant is being called out.

Embodiments of the present invention may generate the unique identifier for each of some or all of the participants represented by the composition output in any of a variety of ways, such as by including one or more of the following components in each such participant's unique identifier, in any order and in any combination:
In the case of a composition that is laid out in a grid, the participant's grid position, which may, for example, include text representing the participant's horizontal coordinate in the grid and text representing the participant's vertical coordinate in the grid. Examples of these are “A2” (indicating horizontal coordinate 1 and vertical coordinate 2), “3-7” (indicating horizontal coordinate 3 and vertical coordinate 7”) and “45” (indicating horizontal coordinate 4 and vertical coordinate 5).
The participant's real name, or any part thereof, e.g., first name (or part thereof, e.g., first letter of first name) and/or last name (or any part thereof, e.g., first letter of last name).
The participant's user ID, e.g., email address, or any part thereof.
An icon.
An emoji.
A color.

Embodiments of the present invention may automatically generate some or all of such components. Embodiments of the present invention may combine any such components together to generate unique identifiers in any way, such as by concatenating two or more such components in any order.

In some embodiments, the techniques described herein relate to a method performed by at least one computer processor executing computer program instructions stored on at least one non-transitory computer-readable medium, the method including: (A) identifying a first plurality of participants, each of which is associated with corresponding metadata; (B) selecting, as a first matching set of participants, a first subset of the first plurality of participants whose corresponding metadata satisfy a first criterion, wherein the first matching set of participants includes at least two of the first plurality of participants and fewer than all of the first plurality of participants; (C) aggregating first data from the first matching set of participants to generate a first composition; and (D) providing the first composition as output.

Operation (C) may include: (C)(1) selecting a first subset of the first matching set of participants as a first set of on-composition participants, wherein the first subset of the first matching set of participants includes at least two of the first matching set of participants and fewer than all of the first matching set of participants; and (C)(2) aggregating the first data from the first set of on-composition participants to generate the first composition.

The first data from the first matching set of participants may include a plurality of audio streams from the first matching set of participants.

The first data from the first matching set of participants may include a plurality of video streams from the first matching set of participants. The first data from the first matching set of participants may include a plurality of audiovisual streams from the first matching set of participants.

The method may further include: (E) identifying an update to the first criterion, resulting in a second criterion; (F) selecting, as a second matching set of participants, a second subset of the first plurality of participants whose corresponding metadata satisfy the second criterion, wherein the second matching set of participants includes at least two of the first plurality of participants and fewer than all of the first plurality of participants; (G) aggregating second data from the second matching set of participants to generate a second composition, wherein the second composition differs from the first composition; and (H) providing the second composition as output.

The method may further include: (E) identifying an update to metadata of a particular one of the first plurality of participants, resulting in updated metadata, wherein the particular one of the first plurality of participants is in the first matching set of participants; (F) selecting, as a second matching set of participants, based at least in part on the updated metadata, a second subset of the first plurality of participants whose corresponding metadata satisfy the first criterion, wherein the second subset of the first plurality of participants differs from the first subset of the first plurality of participants, wherein the particular one of the first plurality of participants is not in the second matching set of participants; (G) aggregating second data from the second matching set of participants to generate a second composition, wherein the second composition differs from the first composition; and (H) providing the second composition as output.

The method may further include: (E) identifying a second criterion that differs from the first criterion; (F) selecting, as a second matching set of participants, a second subset of the first plurality of participants whose corresponding metadata satisfy the second criterion, wherein the second matching set of participants includes at least two of the first plurality of participants and fewer than all of the first plurality of participants, and wherein the second subset of the first plurality of participants differs from the first subset of the first plurality of participants; (G) aggregating second data from the second matching set of participants to generate a second composition, wherein the second composition differs from the first composition; and (H) providing the second composition as output. Operations (D) and (H) may be performed contemporaneously.

Operation (D) may include providing the first composition to a first device; and the method may further include: (E) providing the first composition to a second device; wherein the method may perform (D) and (E) contemporaneously.

Operation (D) may include arranging data derived from the first data within the composition in a particular layout, such as a grid layout.

In some embodiments, the techniques described herein relate to a system including at least one non-transitory computer-readable medium having computer program instructions stored thereon, the computer program instructions being executable by at least one computer processor to perform a method, the method including: (A) identifying a first plurality of participants, each of which is associated with corresponding metadata; (B) selecting, as a first matching set of participants, a first subset of the first plurality of participants whose corresponding metadata satisfy a first criterion, wherein the first matching set of participants includes at least two of the first plurality of participants and fewer than all of the first plurality of participants; (C) aggregating first data from the first matching set of participants to generate a first composition; and (D) providing the first composition as output.

Operation (C) may include: (C)(1) selecting a first subset of the first matching set of participants as a first set of on-composition participants, wherein the first subset of the first matching set of participants includes at least two of the first matching set of participants and fewer than all of the first matching set of participants; and (C)(2) aggregating the first data from the first set of on-composition participants to generate the first composition. The first data from the first matching set of participants may include a plurality of video streams from the first matching set of participants.

The method may further include: (E) identifying an update to the first criterion, resulting in a second criterion; (F) selecting, as a second matching set of participants, a second subset of the first plurality of participants whose corresponding metadata satisfy the second criterion, wherein the second matching set of participants includes at least two of the first plurality of participants and fewer than all of the first plurality of participants; (G) aggregating second data from the second matching set of participants to generate a second composition, wherein the second composition differs from the first composition; and (H) providing the second composition as output.

The method may further include: (E) identifying an update to metadata of a particular one of the first plurality of participants, resulting in updated metadata, wherein the particular one of the first plurality of participants is in the first matching set of participants; (F) selecting, as a second matching set of participants, based at least in part on the updated metadata, a second subset of the first plurality of participants whose corresponding metadata satisfy the first criterion, wherein the second subset of the first plurality of participants differs from the first subset of the first plurality of participants, wherein the particular one of the first plurality of participants is not in the second matching set of participants; (G) aggregating second data from the second matching set of participants to generate a second composition, wherein the second composition differs from the first composition; and (H) providing the second composition as output.

The method may further include: (E) identifying a second criterion that differs from the first criterion; (F) selecting, as a second matching set of participants, a second subset of the first plurality of participants whose corresponding metadata satisfy the second criterion, wherein the second matching set of participants includes at least two of the first plurality of participants and fewer than all of the first plurality of participants, and wherein the second subset of the first plurality of participants differs from the first subset of the first plurality of participants; (G) aggregating second data from the second matching set of participants to generate a second composition, wherein the second composition differs from the first composition; and (H) providing the second composition as output.

Operation (D) may include providing the first composition to a first device; and the method may further include: (E) providing the first composition to a second device; wherein the method may perform operations (D) and (E) contemporaneously.

Operation (D) may include arranging data derived from the first data within the composition in a grid layout.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention dynamically generate, update, and generate output representing a composition of audio/video streams received from a plurality of users over a network. Such functions are inherently rooted in computer technology and cannot be performed mentally or manually by a human.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

What is claimed is:

1. A method performed by at least one computer processor executing computer program instructions stored on at least one non-transitory computer-readable medium, the method comprising:
(A) identifying a first plurality of participants, each of which is associated with corresponding metadata;
(B) selecting, as a first matching set of participants, a first subset of the first plurality of participants whose corresponding metadata satisfy a first criterion, wherein the first matching set of participants comprises at least two of the first plurality of participants and fewer than all of the first plurality of participants;
(C) aggregating first data from the first matching set of participants to generate a first composition; and
(D) providing the first composition as output.

2. The method of claim 1, wherein (C) comprises:
(C)(1) selecting a first subset of the first matching set of participants as a first set of on-composition participants, wherein the first subset of the first matching set of participants comprises at least two of the first matching set of participants and fewer than all of the first matching set of participants; and
(C)(2) aggregating the first data from the first set of on-composition participants to generate the first composition.

3. The method of claim 1, wherein the first data from the first matching set of participants comprises a plurality of audio streams from the first matching set of participants.

4. The method of claim 1, wherein the first data from the first matching set of participants comprises a plurality of video streams from the first matching set of participants.

5. The method of claim 4, wherein the first data from the first matching set of participants comprises a plurality of audiovisual streams from the first matching set of participants.

6. The method of claim 1, further comprising:
(E) identifying an update to the first criterion, resulting in a second criterion;
(F) selecting, as a second matching set of participants, a second subset of the first plurality of participants whose corresponding metadata satisfy the second criterion, wherein the second matching set of participants comprises at least two of the first plurality of participants and fewer than all of the first plurality of participants;
(G) aggregating second data from the second matching set of participants to generate a second composition, wherein the second composition differs from the first composition; and
(H) providing the second composition as output.

7. The method of claim 1, further comprising:
(E) identifying an update to metadata of a particular one of the first plurality of participants, resulting in updated metadata, wherein the particular one of the first plurality of participants is in the first matching set of participants;
(F) selecting, as a second matching set of participants, based at least in part on the updated metadata, a second subset of the first plurality of participants whose corresponding metadata satisfy the first criterion, wherein the second subset of the first plurality of participants differs from the first subset of the first plurality of participants, wherein the particular one of the first plurality of participants is not in the second matching set of participants;
(G) aggregating second data from the second matching set of participants to generate a second composition, wherein the second composition differs from the first composition; and
(H) providing the second composition as output.

8. The method of claim 1, further comprising:
(E) identifying a second criterion that differs from the first criterion;
(F) selecting, as a second matching set of participants, a second subset of the first plurality of participants whose corresponding metadata satisfy the second criterion, wherein the second matching set of participants comprises at least two of the first plurality of participants and fewer than all of the first plurality of participants, and wherein the second subset of the first plurality of participants differs from the first subset of the first plurality of participants;
(G) aggregating second data from the second matching set of participants to generate a second composition, wherein the second composition differs from the first composition; and
(H) providing the second composition as output.

9. The method of claim 8, comprising performing (D) and (H) contemporaneously.

10. The method of claim 1:
wherein (D) comprises providing the first composition to a first device; and
wherein the method further comprises:
(E) providing the first composition to a second device;
wherein the method performs (D) and (E) contemporaneously.

11. The method of claim 1, wherein (D) comprises arranging data derived from the first data within the composition in a particular layout.

12. The method of claim 11, wherein the particular layout comprises a grid layout.

13. A system comprising at least one non-transitory computer-readable medium having computer program instructions stored thereon, the computer program instructions being executable by at least one computer processor to perform a method, the method comprising:
(A) identifying a first plurality of participants, each of which is associated with corresponding metadata;
(B) selecting, as a first matching set of participants, a first subset of the first plurality of participants whose corresponding metadata satisfy a first criterion, wherein the first matching set of participants comprises at least two of the first plurality of participants and fewer than all of the first plurality of participants;
(C) aggregating first data from the first matching set of participants to generate a first composition; and
(D) providing the first composition as output.

14. The system of claim 13, wherein (C) comprises:
(C)(1) selecting a first subset of the first matching set of participants as a first set of on-composition participants, wherein the first subset of the first matching set of participants comprises at least two of the first matching set of participants and fewer than all of the first matching set of participants; and
(C)(2) aggregating the first data from the first set of on-composition participants to generate the first composition.

15. The system of claim 13, wherein the first data from the first matching set of participants comprises a plurality of video streams from the first matching set of participants.

16. The system of claim 13, wherein the method further comprises:
(E) identifying an update to the first criterion, resulting in a second criterion;
(F) selecting, as a second matching set of participants, a second subset of the first plurality of participants whose corresponding metadata satisfy the second criterion, wherein the second matching set of participants comprises at least two of the first plurality of participants and fewer than all of the first plurality of participants;
(G) aggregating second data from the second matching set of participants to generate a second composition, wherein the second composition differs from the first composition; and
(H) providing the second composition as output.

17. The system of claim 13, wherein the method further comprises:
(E) identifying an update to metadata of a particular one of the first plurality of participants, resulting in updated metadata, wherein the particular one of the first plurality of participants is in the first matching set of participants;
(F) selecting, as a second matching set of participants, based at least in part on the updated metadata, a second subset of the first plurality of participants whose corresponding metadata satisfy the first criterion, wherein the second subset of the first plurality of participants differs from the first subset of the first plurality of participants, wherein the particular one of the first plurality of participants is not in the second matching set of participants;
(G) aggregating second data from the second matching set of participants to generate a second composition, wherein the second composition differs from the first composition; and
(H) providing the second composition as output.

18. The system of claim 13, wherein the method further comprises:
(E) identifying a second criterion that differs from the first criterion;
(F) selecting, as a second matching set of participants, a second subset of the first plurality of participants whose corresponding metadata satisfy the second criterion, wherein the second matching set of participants comprises at least two of the first plurality of participants and fewer than all of the first plurality of participants, and wherein the second subset of the first plurality of participants differs from the first subset of the first plurality of participants;
(G) aggregating second data from the second matching set of participants to generate a second composition, wherein the second composition differs from the first composition; and
(H) providing the second composition as output.

19. The system of claim 13:
wherein (D) comprises providing the first composition to a first device; and
wherein the method further comprises:
(E) providing the first composition to a second device;
wherein the method performs (D) and (E) contemporaneously.

20. The system of claim 13, wherein (D) comprises arranging data derived from the first data within the composition in a grid layout.
